(19) United States
(12) Patent Application Publication
(10) Pub. No.: US 2012/0222513 A1
(43) Pub. Date: Sep. 6, 2012

(54) VARIABLE VALVE TIMING DEVICE

(76) Inventor: Masao Sakurai, Tokyo (JP)

(21) Appl. No.: 13/509,026

(22) PCT Filed: Nov. 16, 2010
(86) PCT No.: PCT/JP2010/070395

§ 371 Date: May 10, 2012

(30) Foreign Application Priority Data
Dec. 7, 2009 (JP) 2009 277676

(51) Int. Cl. F16H 35/06

(52) U.S. Cl. 74/397

(57) ABSTRACT

A variable valve timing device, with a simplified structure and reduced cost, reliably and continuously changes a rotational phase of a camshaft relative to a crankshaft, and can change not only valve opening and closing timing but also valve opening and closing times. A first motion gear to which a rotary power is transmitted from a crankshaft and a second motion gear which transmits rotary power to a camshaft are independently rotatably arranged on a first shaft. A first variable gear meshed with the first motion gear and a second variable gear meshed with the second motion gear are integrally rotatably arranged on a second shaft spaced apart from and in parallel with the first shaft. An adjuster holds the second shaft and rotates the second shaft around the first shaft. The first and second variable gears have different numbers of teeth.

### BACKGROUND OF THE INVENTION

1. Technical Field

The present invention relates to a variable valve timing device which changes a rotational phase of a camshaft relative to a crankshaft of an engine, for example, and changes opening and closing timing of an inlet valve and an exhaust valve.

2. Background Art

Recently, in an engine of a car, in order to prevent overlap of an inlet valve and an exhaust valve, enhance output, and realize low fuel consumption, there has been often employed an engine provided with a variable valve timing device which changes a rotational phase of a camshaft relative to a crankshaft of an engine and changes opening and closing timing of an inlet valve and an exhaust valve actuated by a cam of the camshaft.

For this type of conventional variable valve timing device, there has been proposed a variable valve timing device which is provided with an outer gear capable of transmitting a rotative power to a crankshaft of an engine, an inner gear transmitting the rotative power to a camshaft, a planet gear disposed between the outer gear and the inner gear and revolving around the inner gear while meshed with the outer gear and the inner gear, and a motor which is a drive source changing a revolution speed of the planet gear (for example, see Patent Literature 1).

When the variable valve timing device is actually used, the planet gear revolves around the inner gear while meshed with the outer gear and the inner gear, the rotative power of the outer gear is transmitted to the inner gear, and, at the same time, the revolution speed of the planet gear is changed using a motor, whereby the rotational phase of the inner gear relative to the outer gear is changed, and the rotational phase of the camshaft relative to a crankshaft is changed.

### CITATION LIST

### Patent Literature

Patent Literature 1: Japanese Patent Application

Laid-Open No. 2008-267174

However, although the conventional variable valve timing device has an advantage that the revolution speed of the planet gear is changed by the motor to easily change the rotational phase of the inner gear relative to the outer gear, energization control means of the motor as a drive source, rotation detection means and the like are required in order to suitably change the rotational phase of the inner gear relative to the outer gear, whereby the device structure is naturally complicated, and, at the same time, cost may be increased.

### SUMMARY OF THE INVENTION

The present invention was developed to effectively solve the problem with the conventional variable valve timing device. A variable valve timing device according to the present invention changes a rotational phase of a camshaft relative to a crankshaft of an engine and changes opening and closing timing of at least one of an inlet valve and an exhaust valve actuated by a cam of the camshaft, a first motion gear to which a rotative power is transmitted from a crankshaft and a second motion gear which transmits the rotative power to the camshaft are independently rotatably arranged on a first shaft, a first variable gear meshed with the first motion gear and a second variable gear meshed with the second motion gear are integrally rotatably arranged on a second shaft spaced apart from and in parallel with the first shaft, setting is performed so that the number of teeth of the first variable gear and the number of teeth of the second variable gear are different from each other, a gear case which holds the second shaft and rotates the second shaft around the first shaft is provided, rotation control means which controls continuous rotation of the gear case is provided, the rotation control means is constituted of a sliced veneer provided on a side surface of the gear case, an arm whose front end is mutually rotatably connected to the sliced veneer, and an eccentric disc supporting rotatably a base end of the arm and rotating in synchronization with the crankshaft, the second shaft is rotated by the gear case to shift positions of the first and second variable gears, and, thus, to change the rotational phase of the second motion gear relative to the first motion gear and change the rotational phase of the camshaft relative to the crankshaft, and, at the same time, a base end of an arm is displaced by rotation of an eccentric disc of the rotation control means to continuously rotate the gear case in a clockwise direction or a counter clockwise direction, and, thus, to continuously change the rotational phase of the camshaft relative to the crankshaft.

Thus, according to the present invention, in a process that a rotative power is transmitted from a first motion gear, to which the rotative power is transmitted from a crankshaft, to a second motion gear which transmits the rotative power to a camshaft, first and second variable gears with different number of teeth as so-called different gears are integrally rotatably interposed, and the positions of the first and second variable gears are just shifted by a gear case, whereby the rotational phase of the second motion gear relative to the first motion gear can be easily changed. Thus, simplification of the device structure and cost reduction can be realized because the device does not require complex control means, and, at the same time, the rotational phase of the camshaft relative to the crankshaft can be reliably changed, so that a reliable change of the valve opening and closing timing can be secured.

Further, since the positions of the first and second variable gears are easily shifted just by rotating the gear case to allow the rotational phase of the camshaft relative to the crankshaft to be changed, when the gear case is continuously rotated, the rotational phase can be continuously changed, so that not only the valve opening and closing timing but also valve opening and closing times can be changed.

### BRIEF DESCRIPTION OF DRAWINGS

FIG. 1A is a front view showing a state that a variable valve timing device according to a first embodiment is attached to an engine, and FIG. 1B is a partial cross-sectional view along a line A-A in FIG. 1A.

FIG. 2 is a graph showing a phase change of valve operation when a gear case is rotated.

FIG. 3 is a graph showing the phase change of the valve operation according to the magnitude of difference in the number of teeth between a first variable gear and a second variable gear.

FIG. 4 is an explanatory view showing a first example of rotation control means of a gear case in a variable valve timing device according to the first embodiment.

FIG. 5 is an explanatory view showing a second example of the rotation control means of the gear case in the variable valve timing device according to the first embodiment.

FIG. 6 is an explanatory view showing a third example of the rotation control means of the gear case in the variable valve timing device according to the first embodiment.

FIG. 7 is an explanatory view showing a fourth example of the rotation control means of the gear case in the variable valve timing device according to the first embodiment.

FIG. 8A is an explanatory view showing a fifth example of the rotation control means of the gear case in the variable valve timing device according to the first embodiment, and FIG. 8B is an explanatory view showing a support position of an arm base end of FIG. 8A.

FIG. 9 is a graph showing a phase change of valve operation when an eccentric direction of the support position of the arm base end in FIG. 8 is changed.

FIG. 10 is a graph showing the phase change of the valve operation when an eccentric distance of the support position of the arm base end in FIG. 8 is changed.

FIG. 11A is a front view showing a state that a variable valve timing device according to a second embodiment is attached to an engine, and FIG. 11B is a partial cross-sectional view along a line A-A in FIG. 11A.

### DETAILED DESCRIPTION OF THE INVENTION

The present invention provides a variable valve timing device which changes a rotational phase of a camshaft relative to a crankshaft of an engine and changes opening and closing timing of at least one of an inlet valve and an exhaust valve actuated by a cam of the camshaft. In the variable valve timing device, a first motion gear to which a rotative power is transmitted from a crankshaft and a second motion gear which transmits the rotative power to the camshaft are independently rotatably arranged on a first shaft, and a first variable gear meshed with the first motion gear and a second variable gear meshed with the second motion gear are integrally rotatably arranged on a second shaft spaced apart from and in parallel with the first shaft. The variable valve timing device is further provided with adjustment means which holds the second shaft and rotates the second shaft around the first shaft, and setting is performed so that the number of teeth of the first variable gear and the number of teeth of the second variable gear are different from each other. The second shaft is rotated by the adjustment means to shift the positions of the first and second variable gears, whereby the device does not require complex control means in relation to changing the rotational phase of the second motion gear relative to the first motion gear and changing the rotational phase of the camshaft relative to the crankshaft. Therefore, simplification of the device structure and cost reduction can be realized, and, at the same time, the rotational phase of the camshaft relative to the crankshaft can be reliably changed.

### First Embodiment

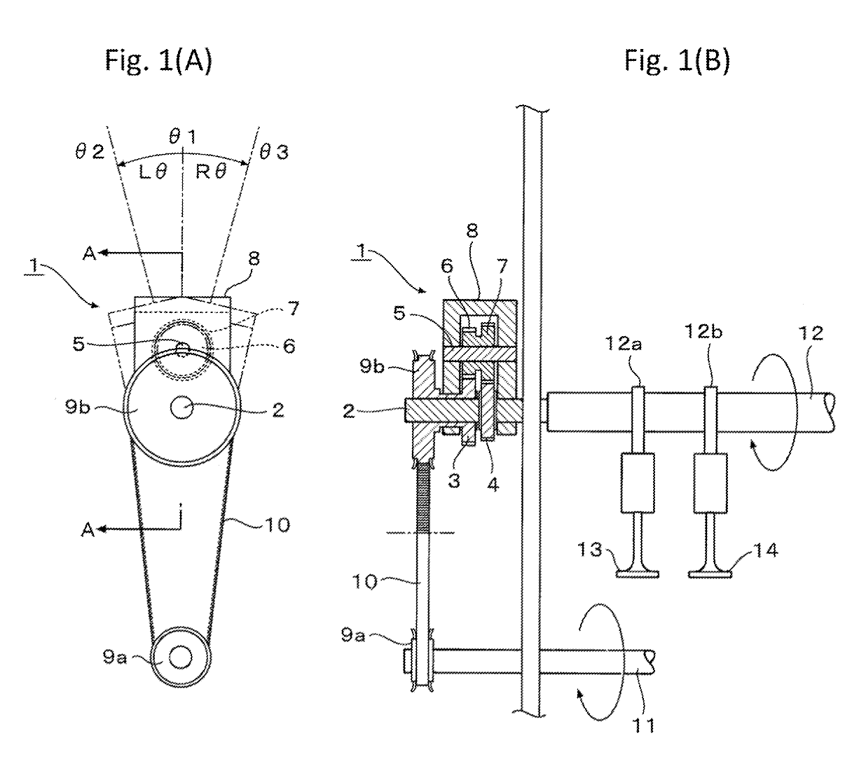

Hereinafter, a variable valve timing device according to a first embodiment will be described in detail in accordance with the preferred embodiments illustrating the present invention. As shown in FIG. 1, a variable valve timing device 1 according to the first embodiment is provided with a first shaft 2 with an extending camshaft 12, a first motion gear 3 disposed on the first shaft 2 in an idle rotatable manner, a second motion gear 4 disposed to be fixed onto the first shaft 2, a second shaft 5 spaced apart from and in parallel with the first shaft 2, a first variable gear 6 and a second variable gear 7 integrally rotatably arranged on the second shaft 5, and a gear case 8 which is adjustment means rotatably supported by the first shaft 2. The gear case 8 is configured to hold the second shaft 5 and store therein the first motion gear 3, the second motion gear 4, the first variable gear 6, and the second variable gear 7.

In this embodiment, a timing pulley 9b on the camshaft 12 side and the first motion gear 3 are integrally formed. When the rotative power of a crankshaft 11 is transmitted from a timing pulley 9a on the crankshaft 11 side to the timing pulley 9b through a timing belt 10, the rotative power is also transmitted to the first motion gear 3.

In the present invention, it is especially important to perform setting so that the number of teeth of the first variable gear 6 and the number of teeth of the second variable gear 7 are different from each other. In this embodiment, the diameter of the first variable gear 6 is smaller than the diameter of the second variable gear 7, and setting is performed so that the number of the teeth of the first variable gear 6 is smaller than the number of the teeth of the second variable gear 7. Accordingly, the diameter of the first motion gear 3 is larger than the diameter of the second motion gear 4 in relation to that a distance between the first shaft 2 and the second shaft 5 is constant.

In this embodiment, although the first variable gear 6 and the second variable gear 7 are integrally formed in order to allow both the gears 6 and 7 to be rotated integrally with each other, the present invention is not limited thereto, and both the gears 6 and 7 maybe formed separately to have connection means, and, thus, to be connected integrally with each other depending on implementation.

Accordingly, in the variable valve timing device 1, when the gear case 8 is located at a fixed reference position θ1 in FIG. 1A, the rotative power of the crankshaft 11 is first transmitted to the timing pulley 9b through the timing pulley 9a and the timing belt 10 and then transmitted to the first motion gear 3 integrally formed with the timing pulley 9b.

Subsequently, the rotative power is transmitted to the first variable gear 6 meshed with the first motion gear 3 and the second variable gear 7 integrally provide with the first variable gear 6 to be then transmitted to the second motion gear 4 meshed with the second variable gear 7, and, thus, to be finally transmitted to the camshaft 12 through the first shaft 2 fixed with the second motion gear 4.

A rotation ratio between the crankshaft 11 and the camshaft 12 will be now described. The camshaft 12 opens and closes inlet valves (exhaust valves) 13 and 14 by means of a cam 12a or 12b of the camshaft 12. Usually, in a four-cycle engine, since the camshaft 12 rotates once while the crankshaft 11 rotates twice, the rotation ratio between the crankshaft 11 and the camshaft 12 is 2:1. Accordingly, each number of the teeth of the first motion gear 3 and the second motion gear 4 is set so that the above rotation ratio is obtained, based on the assumption that the first variable gear 6 and the second variable gear 7 are different from each other in the number of teeth.

Next, a case where the gear case 8 is rotated around the first shaft 2 will be described. When the gear case 8 is rotated by Lθ around the first shaft 2 in a counter clockwise direction in FIG. 1A until reaching θ2, the second shaft 5 held by the gear case 8 is also rotated in the same direction, and a position is shifted while the first variable gear 6 and the second variable gear 7 are meshed respectively with the first motion gear 3 and the second motion gear 4. However, at this time, the rotational phase of the second motion gear 4 relative to the first motion gear 3 is advanced, and the rotational phase of the camshaft 12 relative to the crankshaft 11 is also advanced.

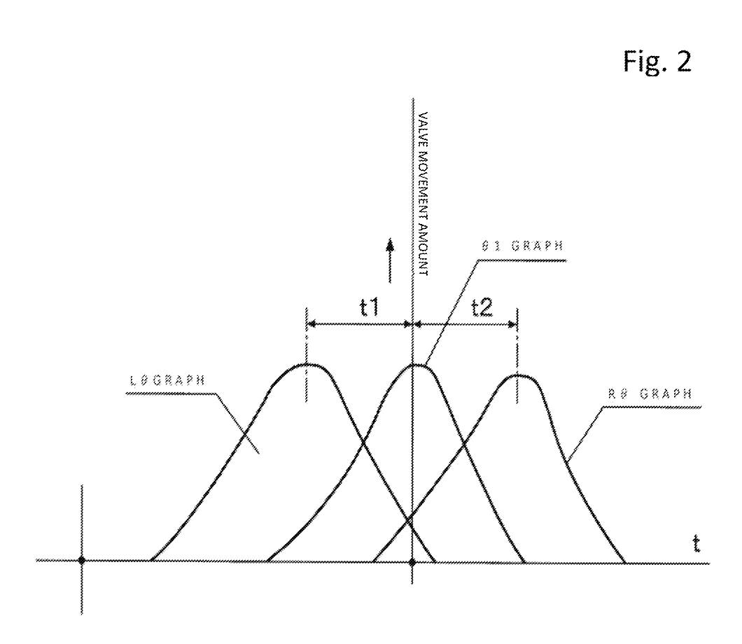

Accordingly, the rotational phase of the camshaft 12 is advanced, and a phase of valve operation of the inlet valves (exhaust valves) 13 and 14 actuated by the cam 12a or 12b of the cam shaft 12 is also advanced, so that, as shown in FIG. 2, the phase of the valve operation when the gear case 8 is rotated by Lθ to θ2 is advanced only by t1 in comparison with the phase of the valve operation when the gear case 8 is located at the fixed reference position θ1. t1 is changed according to the rotation amount Lθ of the gear case 8.

On the other hand, when the gear case 8 is rotated by Rθ around the first shaft 2 in a clockwise direction in FIG. 1A until reaching θ3, the second shaft 5 held by the gear case 8 is also rotated in the same direction, and a position is shifted while the first variable gear 6 and the second variable gear 7 are meshed respectively with the first motion gear 3 and the second motion gear 4. However, at this time, the rotational phase of the second motion gear 4 relative to the first motion gear 3 is delayed, and the rotational phase of the camshaft 12 relative to the crankshaft 11 is also delayed.

Accordingly, the rotational phase of the camshaft 12 is delayed, and the phase of the valve operation of the inlet valves (exhaust valves) 13 and 14 actuated by the cam 12a or 12b of the camshaft 12 is also delayed, so that, as shown in FIG. 2, the phase of the valve operation when the gear case 8 is rotated by Rθ to θ3 is delayed only by t2 in comparison with the phase of the valve operation when the gear case 8 is located at the fixed reference position 01. Also in this case, t2 is changed according to the rotation amount Rθ of the gear case 8.

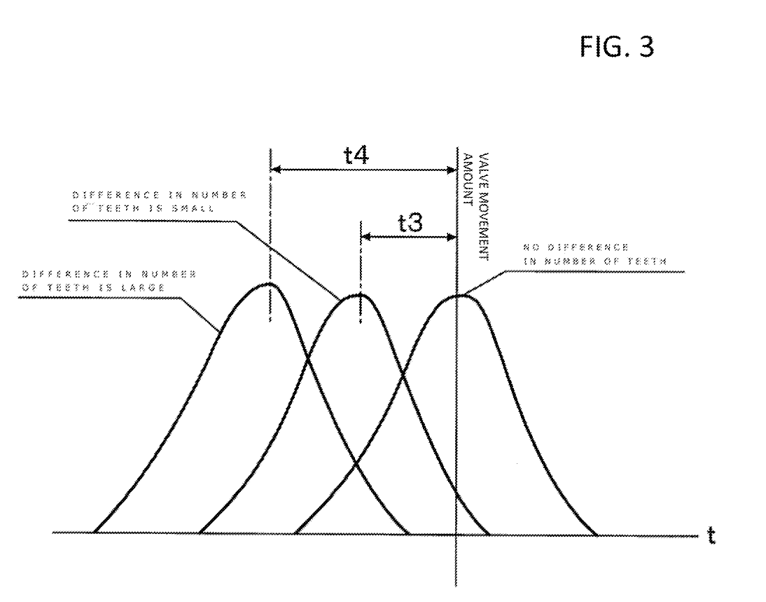

According to the above constitution, the rotational phase of the camshaft can be advanced or delayed according to the rotating direction of the gear case 8, and the amount of changing the rotational phase of the camshaft can be adjusted according to the rotation amount of the gear case 8. However, as shown in FIG. 3, the rotational phase change amount can be adjusted depending on the magnitude of difference in the number of teeth between the first variable gear 6 and the second variable gear 7, and the greater the difference in the number of the teeth of the first variable gear 6 and the second variable gear 7, the larger the rotational phase change amount. Namely, when the gear case 8 is rotated by Lθ in the counter clockwise direction in FIG. 1A until reaching θ2, even if the rotation amount Lθ of the gear case 8 is the same, a phase difference t4 of the valve operation when the difference in the number of the teeth between the first variable gear 6 and the second variable gear 7 is large is larger than a phase difference t3 of the valve operation when the difference in the number of the teeth between the first variable gear 6 and the second variable gear 7 is small.

In this embodiment, the diameter of the first variable gear 6 is smaller than the diameter of the second variable gear 7, and setting is performed so that the number of the teeth of the first variable gear 6 is smaller than the number of the teeth of the second variable gear 7. Accompanying this, although the diameter of the first motion gear 3 is larger than the diameter of the second motion gear 4, the present invention is not limited thereto, and the opposite configuration may be employed. Namely, the diameter of the first variable gear 6 is larger than the diameter of the second variable gear 7, and setting is performed so that the number of the teeth of the first variable gear 6 is larger than the number of the teeth of the second variable gear 7. Accompanying this, the diameter of the first motion gear 3 may be smaller than the diameter of the second motion gear 4 depending on implementation. In this case, unlike this embodiment, when the gear case 8 is rotated in the counter clockwise direction in FIG. 1A, the rotational phase of the camshaft 12 is delayed. Meanwhile, when the gear case 8 is rotated in the clockwise direction in FIG. 1A, the rotational phase of the camshaft 12 is advanced, and the diameter of the second motion gear 4 which transmits the rotative power to the camshaft 12 is large in comparison with this embodiment, results in low revolution. Therefore, the rotational phase change amount of the camshaft 12 is smaller than that in this embodiment.

As described above, according to the present invention, in the process of transmitting the rotative power from the first motion gear 3, to which the rotative power is transmitted from the crankshaft 11, to the second motion gear 4 which transmits the rotative power to the camshaft 12, the first and second variable gears 6 and 7 with different number of teeth as so-called different gears are integrally rotatably interposed, and the device does not require complex control means in relation to just shifting the positions of the first and second variable gears 6 and 7 by the gear case 8 to easily change the rotational phase of the second motion gear 4 relative to the first motion gear 3. Therefore, simplification of the device structure and cost reduction can be realized, and, at the same time, the rotational phase of the camshaft 12 relative to the crankshaft 11 can be reliably changed. Consequently, the opening and closing timing of the inlet valves (exhaust valves) 13 and 14 is reliably changed, and it is possible to prevent overlap of an inlet valve and an exhaust valve, enhance output and realize low fuel consumption of an engine.

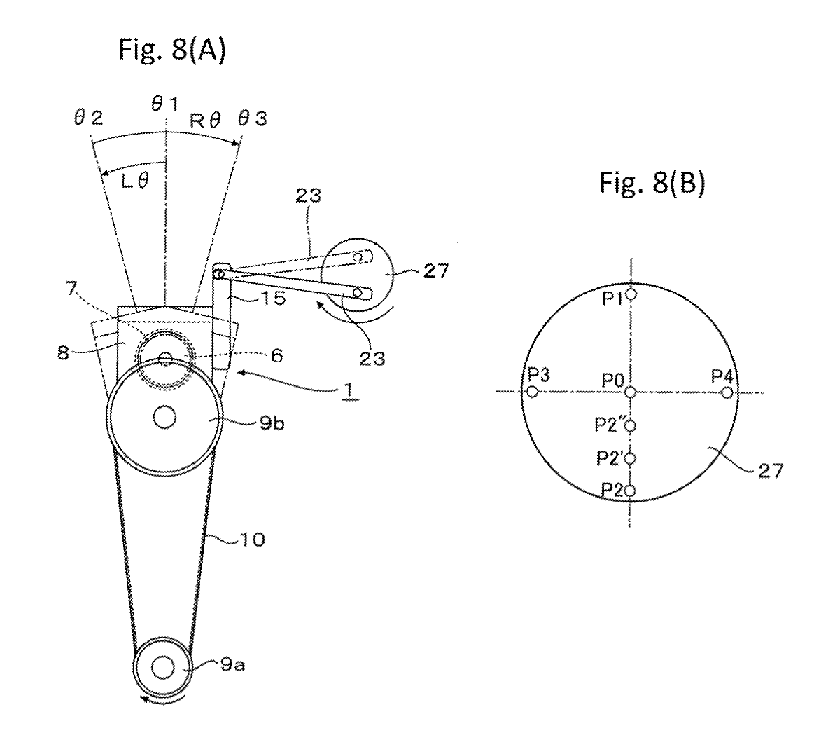

Further, the positions of the first and the second variable gears 6 and 7 are easily shifted just by rotating the gear case 8, and the rotational phase of the camshaft 12 relative to the crankshaft 11 can be changed; therefore, when the gear case 8 is continuously rotated, the rotational phase can be continuously changed, so that not only the opening and closing timing of the inlet valves (exhaust valves) 13 and 14 but also the opening and closing times can be changed as the following description with reference to FIGS. 8 to 10.

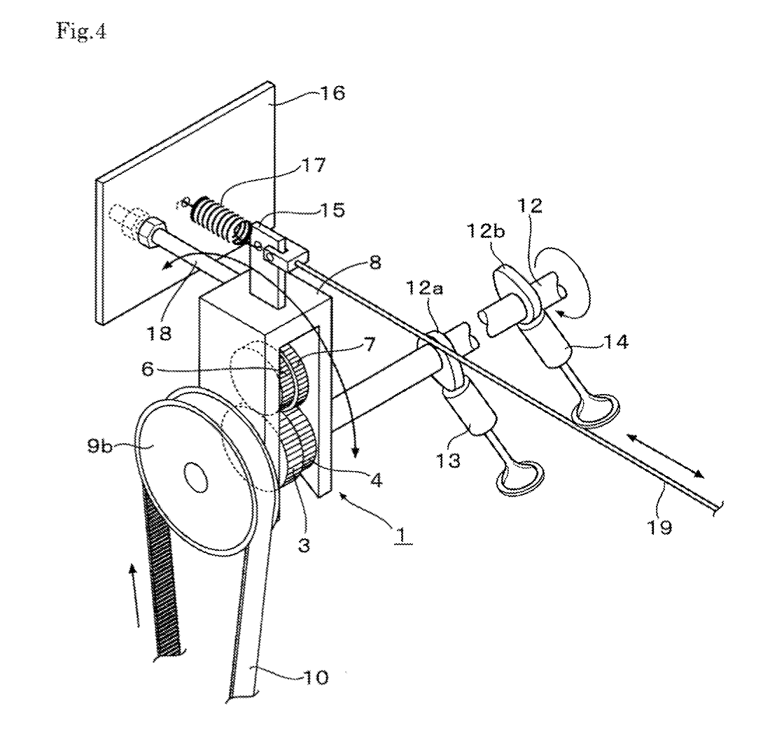

An example of means that controls the rotation of the gear case 8 of the variable valve timing device 1 according to this embodiment will be described according to FIGS. 4 to 10. FIG. 4 shows rotation control means of the gear case 8 configured to be provided with a sliced veneer 15 provided at an upper end of the gear case 8, a draw spring 17 drawing the sliced veneer 15 toward a bracket 16 fixed to an engine frame, a stopper bolt 18 provided at the bracket 16 and controlling the rotation of the gear case 8, and a rod or wire 19 drawing the sliced veneer 15 against an elastic biasing force of the draw spring 17, and the rod or wire 19 performs pulling operation or loosening operation in cooperation with an accelerator. Thus, in the example of FIG. 4, the rod or wire 19 cooperating with the accelerator and the draw spring 17 can rotate the gear case 8 in the clockwise direction or counter clockwise direction in the drawing.

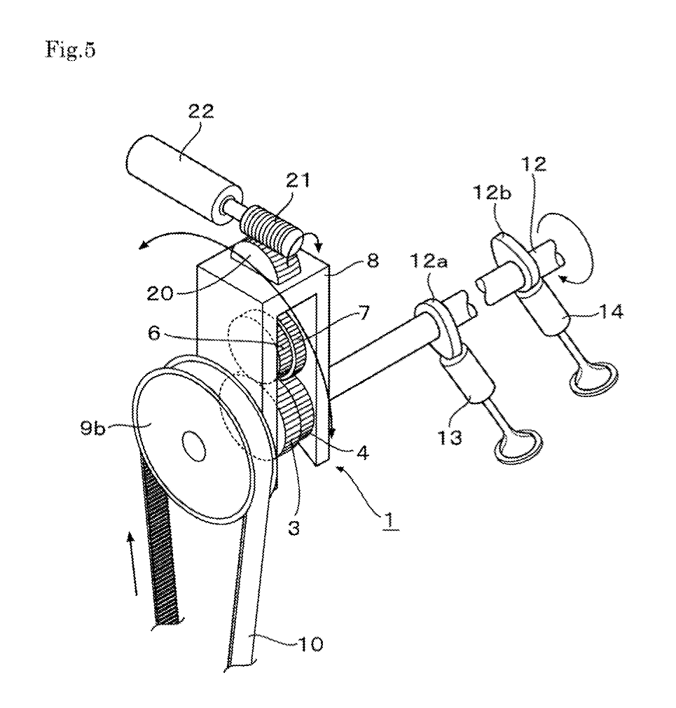

Further, FIG. 5 shows rotation control means of the gear case 8 configured to be provided with a semicircular worm wheel 20 provided at the upper end of the gear case 8, a worm 21 meshed with the worm wheel 20, and a control motor 22 of the worm 21 and adjust the rotating direction of the worm 21 meshed with the worm wheel 20 by means of the control motor 22 to rotate the gear case 8 in the clockwise direction or counter clockwise direction in the drawing.

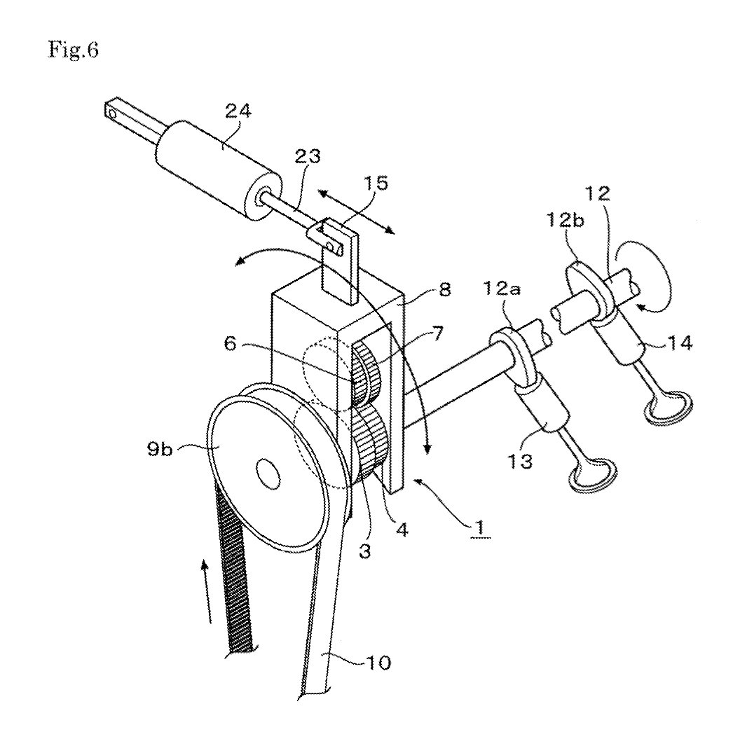

Furthermore, FIG. 6 shows rotation control means of the gear case 8 configured to be provided with the sliced veneer 15 provided at the upper end of the gear case 8, an arm 23 mutually rotatably connected to the sliced veneer 15, and a control actuator 24 for controlling the arm 23 and extend or contract the arm 23 by means of the control actuator 24 to rotate the gear case 8 in the clockwise direction or counter clockwise direction in the drawing.

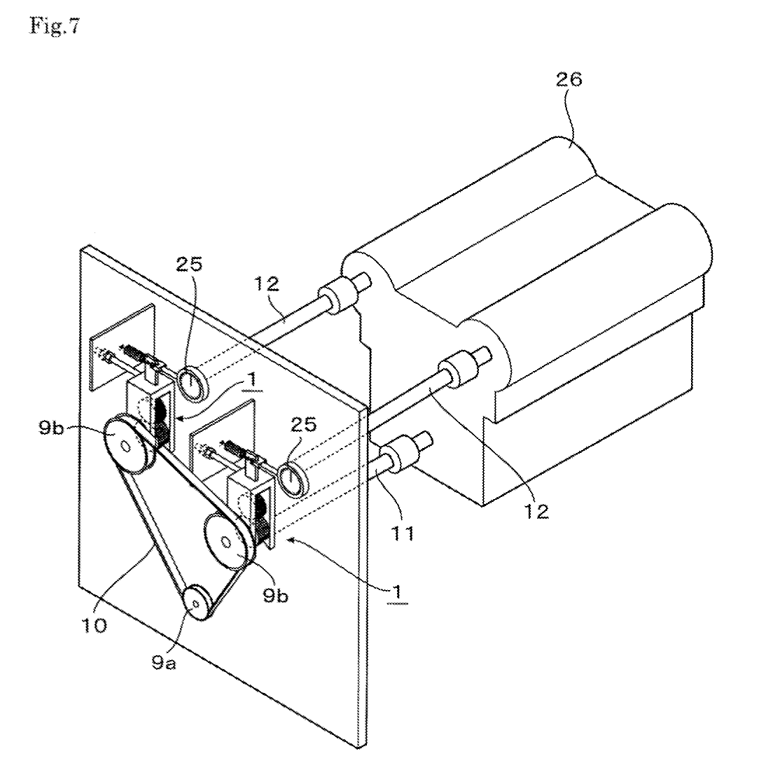

Furthermore, FIG. 7 shows an example in which the variable valve timing device 1 is attached to each camshaft 12 side on the inlet valve side or the exhaust valve side, and the rotation control means of the gear case 8 shown in FIG. 4 is applied to each of the variable valve timing device 1. In this example, each rotation means has a measurement gauge 25, and the rotational phase of each of the camshafts 12 on the inlet valve side or the exhaust valve side can be changed according to the measurement result obtained by the measurement gauge 25. In particular, the rotation control means is effective when used as test equipment that measures output characteristics, fuel consumption, exhaust gas and the like according to a change of the opening and closing timing of the inlet vale or the exhaust valve.

FIG. 8A shows rotation control means used when the gear case 8 is continuously rotated and the rotation control means is configured to be provided with the sliced veneer 15 provided on the side surface of the gear case 8, the arm 23 whose front end is mutually rotatably connected to the sliced veneer 15, and an eccentric disc 27 supporting rotatably a base end of the arm 23 and rotating in synchronization with the timing pulley 9a and displace the base end of the arm 23 by the rotation of the eccentric disc 27 to rotate continuously the gear case 8 in the clockwise direction or counter clockwise direction. FIG. 8B shows a support position of the base end of the arm 23 when the gear case 8 is located at the fixed reference position θ1.

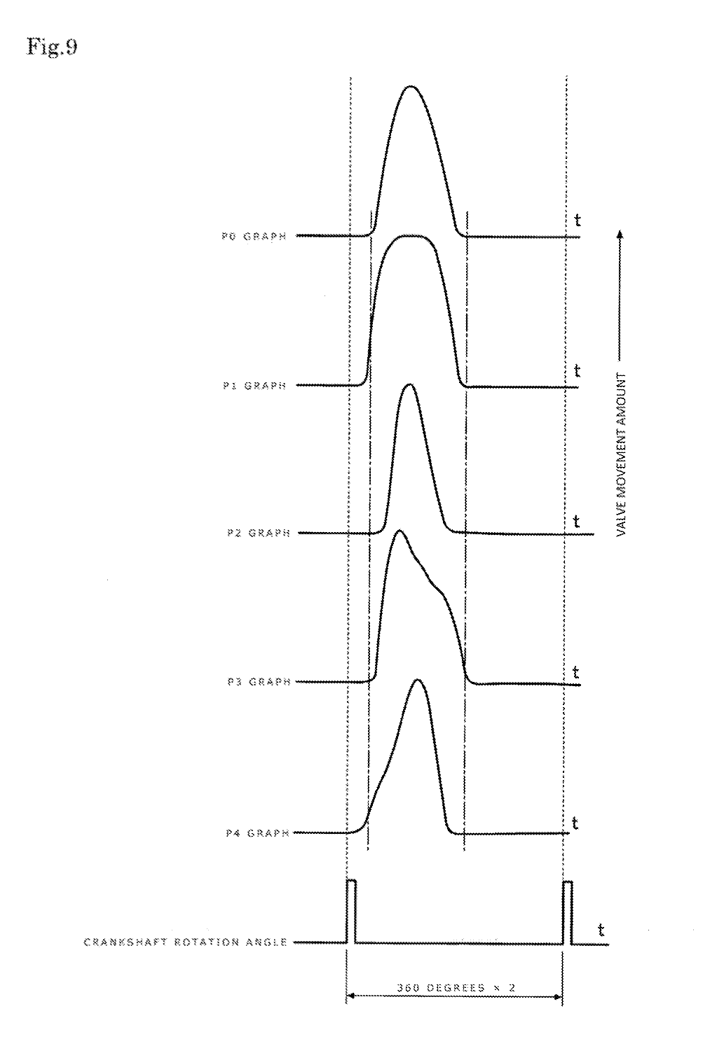

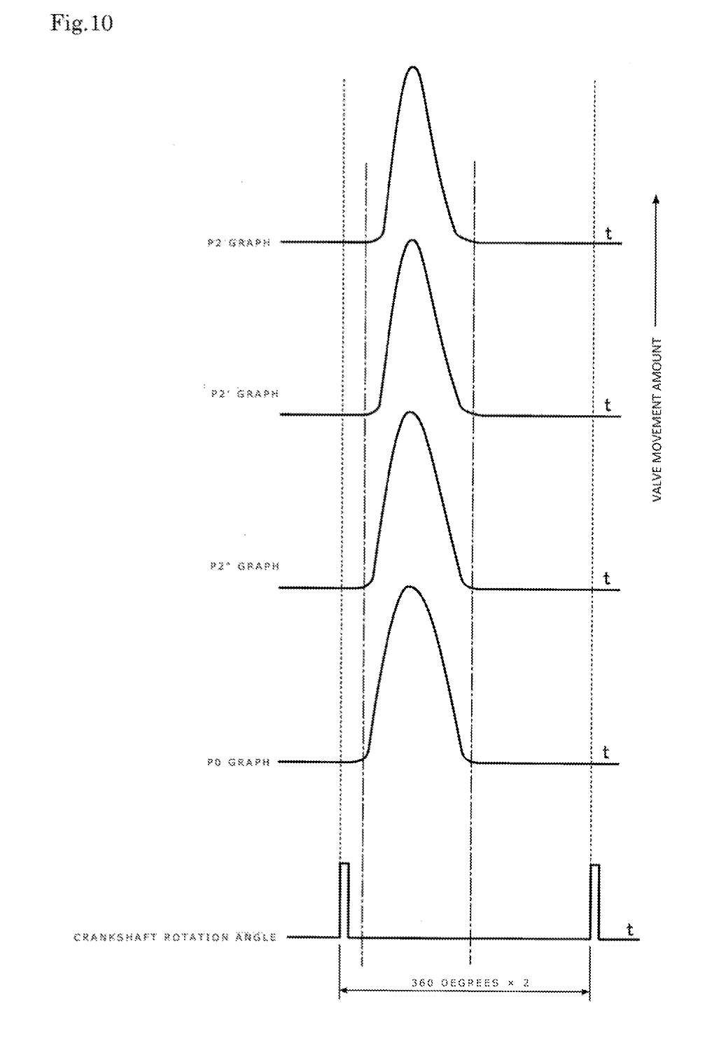

Accordingly, in the above rotation control means, the gear case 8 can be rotated continuously, and if the support position of the base end of the arm 23 when the gear case 8 is located at the fixed reference position θ1 can be adjusted to each position shown in FIG. 8B, the phases of the valve operation different from each other according to the adjusted position are shown as shown in FIGS. 9 and 10.

For example, when the support position of the base end of the arm 23 is adjusted to a position P2 when the gear case 8 is located at the fixed reference position θ1, as shown in FIG. 8A, after the gear case 8 is temporarily rotated by Lθ from the fixed reference position θ1 to θ2 in the counter clockwise direction, the gear case 8 is substantially rotated in the clockwise direction to be rotated by Lθ+Rθ until reaching θ3. Then, the gear case 8 is rotated in the counter clockwise direction to be returned to the fixed reference position θ1. This series of rotation operation can be continuously performed.

Thus, the phase of the valve operation in the above case changes as shown in a P2 graph of FIG. 9 in comparison with a P0 graph of FIG. 9 that is the phase of normal valve operation, and the valve operation time can be reduced in comparison with the normal valve operation time.

Accordingly, in this example, since not only the valve opening and closing timing but also the valve operation time can be changed, it is particularly effective when the valve opening and closing times are required to be adjusted.

### Second Embodiment

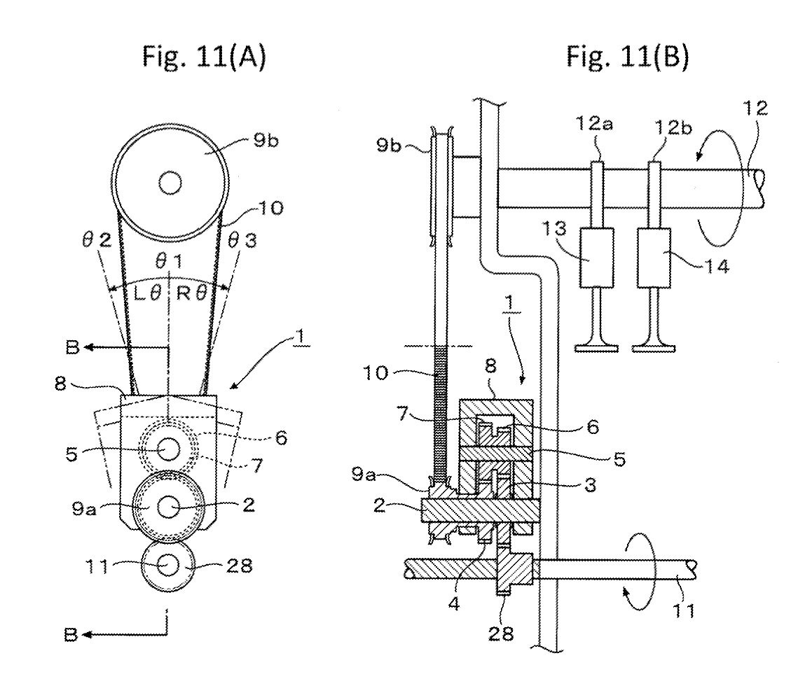

A variable valve timing device 1 in a second embodiment is different from that in the first embodiment and is attached to the crankshaft 11 side. As shown in FIG. 11, the variable valve timing device 1 is provided with a first shaft 2 projectingly provided around the crankshaft 11, a first motion gear 3 disposed on the first shaft 2 in an idle rotatable manner, a second motion gear 4 disposed on the first shaft 2 in an idle rotatable manner, a second shaft 5 spaced apart from and in parallel with the first shaft 2, a first variable gear 6 and a second variable gear 7 integrally rotatably arranged on the second shaft 5, and a gear case 8 which is adjustment means rotatably supported by the first shaft 2. The gear case 8 holds the second shaft 5 and stores therein the first motion gear 3, the second motion gear 4, the first variable gear 6, and the second variable gear 7.

As in the first embodiment, the diameter of the first variable gear 6 is smaller than the diameter of the second variable gear 7, and setting is performed so that the number of teeth of the first variable gear 6 is smaller than the number of teeth of the second variable gear 7. Accordingly, as in the first embodiment, the diameter of the first motion gear 3 is larger than the diameter of the second motion gear 4.

In this embodiment, a crank gear 28 rotating with the crankshaft 11 is provided on the crankshaft 11 side. The crank gear 28 and the first motion gear 3 are meshed with each other to transmit the rotative power of the crankshaft 11 to the first motion gear 3. Meanwhile, the second motion gear 4 and a timing pulley 9a are integrally formed, and the timing pulley 9a rotates simultaneously with the rotation of the second motion gear 4 to transmit the rotative power to the camshaft 12 through the timing belt 10 and the timing pulley 9b on the camshaft 12 side.

Accordingly, the configuration in which the rotative power is transmitted from the crankshaft 11 to the first motion gear 3 and the configuration in which the rotative power is transmitted from the second motion gear 4 to the camshaft 12 are different from those in the first embodiment in relation to changing the attachment position of the variable valve timing device 1 from the camshaft 12 side to the crankshaft 11 side.

Since the operations and effects of the variable valve timing device 1 itself are similar to those of the first embodiment, descriptions of the operations and effects will be omitted here. In this example, it is particularly effective when an attachment space of the variable valve timing device 1 cannot be defined around the camshaft 12 side.

### INDUSTRIAL APPLICABILITY

A variable valve timing device according to the present invention can realize simplification of a device structure and cost reduction in relation to that the device does not require complex control means. At the same time, the rotational phase of a camshaft relative to a crankshaft is reliably and continuously changed, and not only the valve opening and closing timing but also the valve opening and closing times can be changed. Therefore, the variable valve timing device is extremely advantageous when utilized in an engine of a car which attempts to enhance output and realize low fuel consumption.

### REFERENCE SIGNS LIST

1 Variable valve timing device
2 First shaft
3 First motion gear
4 Second motion gear
5 Second shaft
6 First variable gear
7 Second variable gear
8 Gear case (adjustment means)
9a Timing pulley (crankshaft side)
9b Timing pulley (camshaft side)
10 Timing belt
11 Crankshaft
12 Camshaft
12a Cam
12b Cam
13 Inlet valve (exhaust valve)
14 Inlet valve (exhaust valve)
15 Sliced veneer
16 Bracket
17 Draw spring
18 Stopper volt
19 Rod or wire
20 Worm wheel
21 Worm
22 Control motor
23 Arm
24 Control actuator
25 Measurement gauge
26 Engine body
27 Eccentric disc
28 Crank gear
θ1 Fixed reference position
θ2 Rotation position in counter clockwise direction
θ3 Rotation position in clockwise direction
Lθ Rotation amount in counter clockwise direction
Rθ Rotation amount in clockwise direction
t1 Phase difference of valve operation when gear case is rotated by Lθ
t2 Phase difference of valve operation when gear case is rotated by Rθ
t3 Phase difference of valve operation when difference in the number of teeth between first variable gear and second variable gear is small
t4 Phase difference of valve operation when difference in the number of teeth between first variable gear and second variable gear is large
P0 Center position of eccentric disc
P1 First eccentric position
P2 Second eccentric position
P3 Third eccentric position
P4 Fourth eccentric position

1. A variable valve timing device which changes a rotational phase of a camshaft relative to a crankshaft of an engine and changes opening and closing timing of at least one of an inlet valve and an exhaust valve actuated by a cam of the camshaft, a first motion gear to which a rotative power is transmitted from a crankshaft and a second motion gear which transmits the rotative power to the camshaft being independently rotatably arranged on a first shaft, a first variable gear meshed with the first motion gear and a second variable gear meshed with the second motion gear being integrally rotatably arranged on a second shaft spaced apart from and in parallel with the first shaft, setting being performed so that the number of teeth of the first variable gear and the number of teeth of the second variable gear are different from each other, a gear case which holds the second shaft and rotates the second shaft around the first shaft being provided, rotation control means which controls continuous rotation of the gear case being provided, the rotation control means being constituted of a sliced veneer provided on a side surface of the gear case, an arm whose front end is mutually rotatably connected to the sliced veneer, and an eccentric disc supporting rotatably a base end of the arm and rotating in synchronization with the crankshaft, the second shaft being rotated by the gear case to shift positions of the first and second variable gears, and, thus, to change the rotational phase of the second motion gear relative to the first motion gear and change the rotational phase of the camshaft relative to the crankshaft, and, at the same time, a base end of an arm being displaced by rotation of an eccentric disc of the rotation control means to continuously rotate the gear case in a clockwise direction or a counter clockwise direction, and, thus, to continuously change the rotational phase of the camshaft relative to the crankshaft.
